(19) United States
(12) Patent Application Publication
(10) Pub. No.: US 2018/0108356 A1
(43) Pub. Date: Apr. 19, 2018

(54) VOICE PROCESSING APPARATUS, WEARABLE APPARATUS, MOBILE TERMINAL, AND VOICE PROCESSING METHOD

(71) Applicant: HONDA MOTOR CO., LTD., Tokyo (JP)

(72) Inventors: Takeshi Mizumoto, Wako-shi (JP); Kazuhiro Nakadai, Wako-shi (JP)

(21) Appl. No.: 15/645,010

(22) Filed: Jul. 10, 2017

(30) Foreign Application Priority Data
Oct. 17, 2016 (JP) 2016-203690

(51) Int. Cl. G10L 15/26; G06F 3/16; G06F 3/14

(52) U.S. Cl. CPC G10L 15/265; G06F 3/017; G06F 3/14; G06F 3/167

(57) ABSTRACT

A voice processing apparatus includes: a scenario storing unit configured to store a scenario as text information; a sound collecting unit configured to collect sound uttered by an utterer; a voice recognizing unit configured to perform voice recognition on the sound collected by the sound collecting unit; and a subtitle generating unit configured to read the text information from the scenario storing unit, to generate subtitles, and to change a display of a portion which has been already uttered by the utterer in a character string of the subtitles on the basis of a result of voice recognition by the voice recognizing unit.

### CROSS-REFERENCE TO RELATED APPLICATION

Priority is claimed on Japanese Patent Application No. 2016-203690, filed Oct. 17, 2016, the content of which is incorporated herein by reference.

### BACKGROUND OF THE INVENTION

### Field of the Invention

The present invention relates to a voice processing apparatus, a wearable apparatus, a mobile terminal, and a voice processing method.

### Description of Related Art

At presentation sessions of academic societies and the like, presenters memorize prepared manuscripts and perform presentations or perform presentations while reading manuscripts. Since presenters' faces face manuscripts when the presenters perform presentations while viewing the manuscripts, the presentations cannot be performed while their faces face an audience. For this purpose, presenters can read manuscripts displayed on teleprompters or the like.

For example, Japanese Patent No. 3162832 (hereinafter, Patent Literature 1) discloses a constitution in which voice recognition is performed on content uttered by an utterer such as an announcer, utterance content is acquired as text information, and the text information is superimposed on a display image as a subtitle super.

### SUMMARY OF THE INVENTION

However, although the content uttered by the utterer can be displayed through voice recognition as subtitles in the technology disclosed in Patent Literature 1, an assist function in which content determined by a scenario in advance is displayed in subtitles and thus the utterer can correctly read it is not provided.

An aspect according to the present invention was made in view of the above-described problems and an objective of the present invention is to provide a voice processing apparatus, a wearable apparatus, a mobile terminal, and a voice processing method in which efficiency and effects of a presentation in a situation such as a conference can be improved.

In order to accomplish the above-described objective, the present invention adopts the following aspects.

(1) A voice processing apparatus according to an aspect of the present invention includes: a scenario storing unit configured to store a scenario as text information; a sound collecting unit configured to collect sound uttered by an utterer; a voice recognizing unit configured to perform voice recognition on the sound collected by the sound collecting unit; and a subtitle generating unit configured to read the text information from the scenario storing unit, to generate subtitles, and to change a display of a portion which has been already uttered by the utterer in a character string of the subtitles on the basis of a result of voice recognition by the voice recognizing unit.

(2) In the aspect of (1), the subtitle generating unit may detect whether skipping by the utterer has occurred in the subtitles on the basis of voice recognition in the voice recognizing unit and change display of a portion including a corresponding portion when it is detected that the skipping by the utterer has occurred in the subtitle.

(3) In the aspect of (1) or (2), the voice recognizing unit may acquire an operation instruction from voice-recognized sound, and the subtitle generating unit may perform at least one of reproducing, pausing, and ending of the subtitles on the basis of the operating instruction.

(4) In the aspect of (3), the scenario may have been composed from a plurality of items in advance, and the subtitle generating unit may reproduce subtitles of an item designated through the operation instruction.

(5) In the aspect of any one of (1) to (4), the voice processing apparatus further includes a receiving unit configured to acquire instruction information from the outside, wherein the subtitle generating unit may display the instruction information acquired by the receiving unit in a region other than a region in which the subtitles are displayed.

(6) A wearable apparatus according to an aspect of the present invention includes: a scenario storing unit configured to store a scenario as text information; a sound collecting unit configured to collect sound uttered by an utterer; a voice recognizing unit configured to perform voice recognition on the sound collected by the sound collecting unit; a display unit configured to display the text information; and a subtitle generating unit configured to read the text information from the scenario storing unit, to generate a subtitle, to change display of a portion which has been already uttered by the utterer in a character string of the subtitles on the basis of a result of voice recognition by the voice recognizing unit, and to display the portion on the display unit.

(7) A mobile terminal according to an aspect of the present invention includes: a scenario storing unit configured to store a scenario as text information; a sound collecting unit configured to collect sound uttered by an utterer; a voice recognizing unit configured to perform voice recognition on the sound collected by the sound collecting unit; a display unit configured to display the text information; and a subtitle generating unit configured to read the text information from the scenario storing unit, to generate subtitles, to change display of a portion which has been already uttered by the utterer in a character string of the subtitles on the basis of a result of voice recognition by the voice recognizing unit, and to display the portion on the display unit.

(8) A voice processing method according to an aspect of the present invention is a voice processing method in a voice processing apparatus having a scenario storing unit configured to store a scenario as text information, the voice processing method including: a sound collecting step of collecting, by a sound collecting unit, sound uttered by an utterer; a voice recognizing step of performing, by a voice recognizing unit, voice recognition on the sound collected by the sound collecting step; and a subtitle generating step of reading, by a subtitle generating unit, the text information from the scenario storing unit, to generate subtitles, to change display of a portion which has been already uttered by the utterer in a character string of the subtitles on the basis of a result of voice recognition by the voice recognizing unit, and to display the portion on the display unit.

According to the aspects of (1), (6), (7), and (8), subtitles uttered by an utterer is hidden so that an utterer can be guided to easily talk about a predetermined scenario.

Also, in the case of (2), even when there is skipping, the utterer can continue talking smoothly.

In the case of (3), reproducing, pausing, stopping, or the like of subtitles of a desired scenario can be performed on the basis of an operation instruction by an utterer.

In the case of (4), a desired scenario of an utterer or subtitles from a chapter can be reproduced.

In the case of (5), an instruction from the outside can be displayed without disturbing display of subtitles.

### BRIEF DESCRIPTION OF THE DRAWINGS

FIG. 1 is a block diagram showing a constitution of a voice processing apparatus according to a first embodiment.

FIG. 2 is a diagram illustrating an example of a manuscript file stored in a scenario storing unit according to the first embodiment.

FIG. 3 is a diagram illustrating an example of an exterior of the voice processing apparatus according to the first embodiment.

FIG. 4 is a diagram illustrating an example of information displayed on a display unit according to the first embodiment.

FIG. 5 is a diagram illustrating a display example when skipping has occurred according to the first embodiment.

FIG. 6 is a flowchart of a process of an operation instruction using voice signals according to the first embodiment.

FIG. 7 is a flowchart of a process during a presentation according to the first embodiment.

FIG. 8 is a block diagram showing a constitution of a voice processing apparatus according to a second embodiment.

### DETAILED DESCRIPTION OF THE INVENTION

Hereinafter, embodiments of the present invention will be described with reference to the drawings.

### First Embodiment

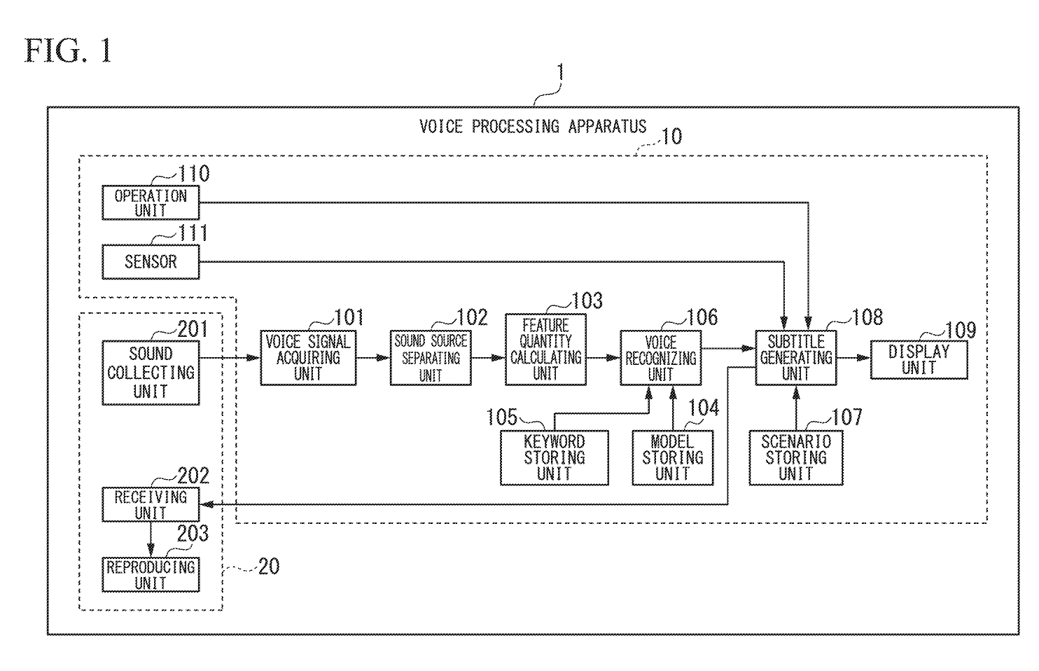

FIG. 1 is a block diagram showing a constitution of a voice processing apparatus 1 according to this embodiment.

As shown in FIG. 1, the voice processing apparatus 1 includes a head mounted display (HMD) 10 and a headset 20.

The HMD 10 includes a voice signal acquiring unit 101, a sound source separating unit 102, a feature quantity calculating unit 103, a model storing unit 104, a keyword storing unit 105, a voice recognizing unit 106, a scenario storing unit 107, a subtitle generating unit 108, a display unit 109, an operation unit 110, and a sensor 111.

The headset 20 includes a sound collecting unit 201, a receiving unit 202, and a reproducing unit 203.

The voice processing apparatus 1 collects voice signals of a user serving as a presenter and performs voice recognition on the collected voice signals. The voice processing apparatus 1 displays text which is set such that a portion from which the user has read cannot be seen from text of a manuscript file serving as a scenario which has been stored. Furthermore, the voice processing apparatus 1 detects whether skipping has occurred on the basis of a result of performing voice recognition on an utterance of the user, detects a previous skipped position (a clause or the like) when the skipping has occurred, and displays text from the position. The voice processing apparatus 1 detects an operation of the user and performs starting, pausing, or stopping of display of text, starting of display for each item, or the like. Here, an item is, for example, a collection of text such as a paragraph and a chapter. The voice processing apparatus 1 receives instruction information output by an external apparatus and reproduces the received instruction information using voice signals or displays the received instruction information using text. The external apparatus is, for example, a computer, a smartphone, a tablet terminal, or the like. Furthermore, instructions to the presenter are included in the instruction information. Here, the instructions to the presenter is, for example, the expression “please insert a little pause” or the like.

The HMD 10 acquires the sound signals collected by the headset 20 and performs a voice recognition process on the acquired sound signals. The HMD 10 displays text of a manuscript file which is set such that a portion from which the user has read cannot be seen from text of the manuscript file which has been stored on the display unit 109. The HMD 10 detects whether skipping has occurred on the basis of a result of performing voice recognition on an utterance of the user, detects a previous skipped position (a clause or the like) when the skipping has occurred, and displays text from the position. The HMD 10 displays instruction information output by the headset 20. The HMD 10 detects at least one operation of the user among an operation through a voice, an operation through the operation unit 110, and an operation through a gesture. The HMD 10 performs starting, pausing, or stopping of display of text, starting of display for each item, or the like in accordance with the detected result. Note that a gesture is a motion in which the user on the head of which the HMD 10 of the voice processing apparatus 1 is being worn shakes the head in a horizontal direction or a vertical direction. Moreover, the HMD 10 may have functions of the entire voice processing apparatus 1 and the HMD may be a mobile terminal such as a head up display (HUD), a wearable terminal, and a smartphone, a teleprompter, and the like.

The headset 20 collects an utterance of the user and outputs the collected sound signals to the HMD 10. The headset 20 receives instruction information output by an external apparatus and reproduces the received instruction information from a speaker or outputs the received instruction information to the HMD 10.

The sound collecting unit 201 is a microphone disposed near the user's mouth. The sound collecting unit 201 collects the user's voice signals and outputs the collected voice signals to the voice signal acquiring unit 101. Note that the sound collecting unit 201 may convert the voice signals from analog signals into digital signals and output the converted voice signals serving as digital signals to the voice signal acquiring unit 101.

The voice signal acquiring unit 101 performs, for example, a discrete Fourier transform (DFT) on a voice signal x(k) (k is an integer indicating a sampling time) output by the sound collecting unit 201, generates a frequency domain signal x(w) (w is a frequency), and outputs the generated frequency domain signal x(w) to the sound source separating unit 102.

The sound source separating unit 102 extracts, for example, voice signals which have a predetermined threshold value or more from sound signals of a frequency domain output by the voice signal acquiring unit 101 to separate voice signals of an utterer. The sound source separating unit 102 outputs the separated voice signals to the feature quantity calculating unit 103. Note that the sound source separating unit 102 may minimize reverberation signals.

The feature quantity calculating unit 103 calculates an acoustic feature quantity from voice signals output by the sound source separating unit 102 and outputs the calculated acoustic feature quantity to the voice recognizing unit 106. The feature quantity calculating unit 103 calculates, for example, a static Mel-scale log spectrum (MSLS), delta MSLS, and one delta power at predetermined time intervals (for example, every 10 ms) to calculate an acoustic feature quantity. Note that the MSLS is obtained by performing an inverse discrete cosine transform on a Mel-frequency cepstrum coefficient (MFCC) using a spectrum feature quantity as a feature quantity of acoustic recognition.

The model storing unit 104 stores a voice recognition model and a language model. The voice recognition model is constituted of, for example, waveform data of voice signals for each phoneme. Note that an acoustic model may be generated from voice signals of a large number of people in advance and generated using the user's voice signals. Furthermore, a language model is constituted of information such as words, dependency thereof, and arrangement thereof.

The keyword storing unit 105 associates keywords used to instruct an operation with operation instructions and stores the associations. Here, the operation instructions are, for example, an instruction to start generation of subtitle data, an instruction to pause generation of subtitle data, an instruction to end generation of subtitle data, and the like. Furthermore, the keywords used to instruct an operation are, for example, a keyword of a signal to start a presentation, a keyword of a signal to start description of an item, a keyword of a signal to end a presentation, and the like.

The voice recognizing unit 106 performs a voice recognition process using a voice feature quantity output by the feature quantity calculating unit 103 and an acoustic model and a language model stored in the model storing unit 104. The voice recognizing unit 106 determines a phrase with the highest likelihood calculated using the acoustic model and the language model with respect to a voice feature quantity as a recognition result. The voice recognizing unit 106 generates a recognition result serving as a result of voice recognition in a text format. The voice recognizing unit 106 generates, for example, text for each word. The voice recognizing unit 106 retrieves a keyword stored in the keyword storing unit 105 after the voice recognition process and determines whether the keyword is included in the recognition result. The voice recognizing unit 106 outputs an operation instruction corresponding to the keyword to the subtitle generating unit 108 when it is determined that the keyword is included in the recognition result. The voice recognizing unit 106 outputs the recognition result to the subtitle generating unit 108, for example, for each word when it is determined that the keyword is not included in the recognition result.

The scenario storing unit 107 stores a manuscript file used in a presentation, for example, in a text format. The voice processing apparatus 1 acquires a manuscript file from an external apparatus such as a computer and stores the acquired manuscript file in the scenario storing unit 107. The manuscript file may includes item. The scenario storing unit 107 stores a relationship between a threshold value of a detection value of the sensor 111 and an operation instruction.

The subtitle generating unit 108 acquires the recognition result output by the voice recognizing unit 106. The subtitle generating unit 108 reads a manuscript file stored in the scenario storing unit 107. The subtitle generating unit 108 retrieves a portion corresponding to the manuscript file read by the acquired recognition result. The subtitle generating unit 108 generates subtitle data of the manuscript from the beginning thereof to the corresponding portion, for example, with a changed display color and outputs the generated subtitle data to the display unit 109. The subtitle generating unit 108 generates an operation image and outputs the generated operation image to the display unit 109. Here, the operation images are, for example, a button image associated with starting of a presentation for starting a presentation, a button image associated with stopping of a presentation for stopping a presentation, a button image associated with displaying of a main menu, and the like. The subtitle generating unit 108 generates instruction subtitle data to display the instruction information output by the receiving unit 202 outside of a presentation unit used to display a manuscript file and outputs the generated instruction subtitle data to the display unit 109.

Also, the subtitle generating unit 108 detects that an operation has been performed by the user on the basis of an operation result output by the operation unit 110 or the detection value output by the sensor 111. The subtitle generating unit 108 starts, pauses, or end generation of subtitle data on the basis of the operation result output by the operation unit 110 or the detection value output by the sensor 111 when it is detected that an operation has been performed by the user. For example, the subtitle generating unit 108 starts generation of subtitle data when the detection value of the sensor 111 is a predetermined first threshold value or more and a predetermined second threshold value or less or when the number of operation results of the operation unit 110 is one. The subtitle generating unit 108 pauses generation of subtitle data when the detection value of the sensor 111 is the predetermined second threshold value or more and a predetermined third threshold value or less or when the number of operation results of the operation unit 110 is two. The subtitle generating unit 108 ends generation of subtitle data when the detection value of the sensor 111 is the predetermined third threshold value or more or when the number of operation results of the operation unit 110 is three. Alternatively, when the operation result output by the operation unit 110 is coordinate data on the display unit 109, the subtitle generating unit 108 starts, pauses, or ends generation of subtitle data on the basis of the coordinate data. The subtitle generating unit 108 may detect, for example, that the user has shaken their head to the left and right on the basis of a detection value of the sensor 111 and determine this to be an operation instruction used to start generation of subtitle data. Note that the number of operation results and the threshold values of the detection value which have been described above are merely examples and the present invention is not limited thereto.

When the voice recognizing unit 106 outputs an operation instruction, the subtitle generating unit 108 performs starting of reproduction of a scenario, starting of reproduction of a scenario of an item, ending of reproduction of a scenario, and the like in response to the operation instruction.

The display unit 109 is, for example, a liquid crystal display apparatus or an organic electroluminescence (EL) display apparatus and displays subtitle data and instruction subtitle data output by the subtitle generating unit 108.

The operation unit 110 is, for example, a touch sensor or a pointing apparatus such as a trackball and a stick. The operation unit 110 detects a result of an operation by the user and outputs the detected operation result to the subtitle generating unit 108.

The sensor 111 is at least one of an acceleration sensor, a geomagnetic sensor, and an angular velocity sensor. The sensor 111 outputs the detected detection value to the subtitle generating unit 108. The subtitle generating unit 108 uses a detection value of an acceleration sensor for inclination detection of the HMD 10.

An acceleration sensor is, for example, a three-axis sensor and detects acceleration of gravity. The subtitle generating unit 108 uses a detection value of a geomagnetic sensor for the purpose of detecting bearings of the HMD 10. The subtitle generating unit 108 uses a detection value of an angular velocity sensor (a gyro sensor) for the purpose of detecting a rotation of the HMD 10.

The receiving unit 202 receives instruction information transmitted by an external apparatus. The receiving unit 202 outputs the received instruction information to the reproducing unit 203 when the received instruction information is sound signals. The receiving unit 202 outputs the received instruction information to the subtitle generating unit 108 when the received instruction information is text data.

The reproducing unit 203 is a speaker or an earphone and reproduces sound signals output by the receiving unit 202.

Note that, when a plurality of sound collecting units 201 are installed, for example, on a stage without being disposed near the user's mouth, the voice processing apparatus 1 may include a sound source localization unit between the voice signal acquiring unit 101 and the sound source separating unit 102. In this case, the plurality of sound collecting units 201 are N (N is an integer of 2 or more) microphones and may be regarded as a microphone array. The sound source localization unit calculates a spatial spectrum with respect to voice signals of N channels output by the voice signal acquiring unit 101 using a transfer function stored in the unit itself. The sound source localization unit performs estimation (hereinafter also referred to as a “sound source localization”) of an azimuth angle of a sound source on the basis of the calculated spatial spectrum. The sound source localization unit outputs the estimated azimuth angle information of the sound source and the input voice signals of the N channels to the sound source separating unit 102. The sound source localization unit estimates an azimuth angle, for example, using a Multiple Signal Classification (MUSIC) method. Note that, in order to estimate an azimuth angle, other sound source direction estimation methods such as a beamforming method, a weighted delay and sum beamforming (WDS-BF) method, and a MUSIC using generalized specific value development (Generalized Singular Value Decomposition-MUltiple SIgnal Classification; GSVD-MUSIC) method may be used. In this case, the sound source separating unit 102 acquires the sound signals of the N channels output by the sound source localization unit and the estimated azimuth angle information of the sound source. The sound source separating unit 102 reads the acquired transfer function corresponding to the azimuth angle from the sound source localization unit. The sound source separating unit 102 separates voice signals for each sound source from the acquired sound signals of the N channels using a Geometrically constrained Highorder Decorrelation based Source Separation with Adaptive Stepsize control (GHDSS-AS) method serving as a hybrid of the read transfer function and, for example, blind separation and beam forming. Note that the sound source separating unit 102 may perform a sound source separating process using, for example, a beam forming method.

Next, an example of a manuscript file stored in the scenario storing unit 107 will be described.

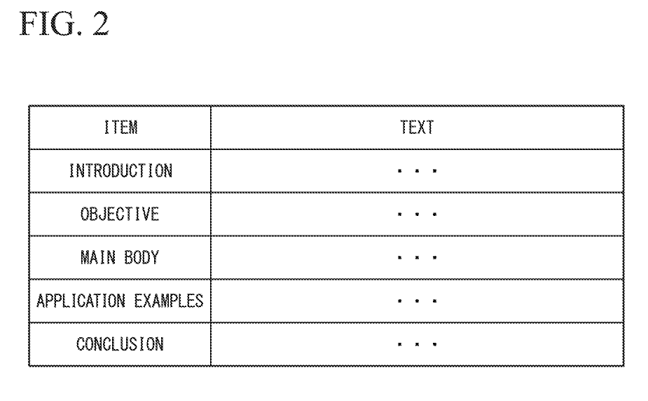

FIG. 2 is a diagram illustrating an example of a manuscript file stored in the scenario storing unit 107 according to this embodiment. The manuscript file of the example illustrated in FIG. 2 is an example of a manuscript file used when such is presented in an academic society or the like. As shown in FIG. 2, the scenario storing unit 107 stores text for each item. Items are, for example, “Introduction,” “Objective,” “Main body,” “Application examples,” and “Conclusion.” Note that names of items illustrated in FIG. 2 are merely examples and the present invention is not limited thereto. In addition, the names may be for example, a first paragraph, a second paragraph, . . . , first, second, . . . , Chapter 1, Chapter 2, . . . , and the like.

When the voice recognizing unit 106 has output an operation instruction of an item of, for example, “Introduction,” the subtitle generating unit 108 starts generation of subtitle data of text of the item of “Introduction.” Voice signals of the operation instruction of the item of “Introduction” indicate, for example, “Then, let's begin the presentation.” Furthermore, voice signals of an operation instruction of the item of the “Objective” indicate, for example, “The section about the objective will be explained.”

Note that the scenario storing unit 107 may store a plurality of manuscript files. In this case, the user selects a manuscript file used for a presentation by an operation through a voice, an operation of the operation unit 110, or an operation through a gesture from the plurality of manuscript files.

In this case, the subtitle generating unit 108 displays titles of a plurality of manuscript files stored in the scenario storing unit 107 on the display unit 109. The user selects a manuscript file used for a presentation from the titles displayed when the operation unit 110 is operated. Alternatively, the user reads titles or the like of a manuscript used for the presentation from the displayed titles. When keywords of the titles or the like of the presented manuscript are included in the acquired voice signals, the voice recognizing unit 106 outputs an operation instruction used to select a corresponding manuscript file to the subtitle generating unit 108.

Next, an example of an exterior of the voice processing apparatus 1 will be described.

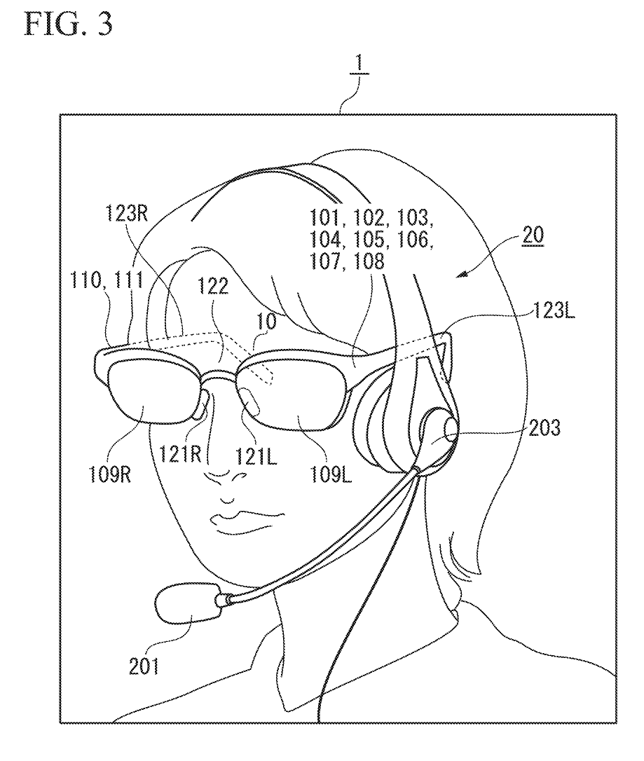

FIG. 3 is a diagram illustrating the example of the exterior of the voice processing apparatus 1 according to this embodiment. As shown in FIG. 3, the voice processing apparatus 1 includes the eyeglass type HMD 10 and the headset 20. The HMD 10 includes right and left display units 109R and 109L, right and left nose pads 121R and 121L, a bridge 122, and right and left temples 123R and 123L. The left temple 123L includes the voice signal acquiring unit 101, the sound source separating unit 102, the feature quantity calculating unit 103, the model storing unit 104, the keyword storing unit 105, the voice recognizing unit 106, the scenario storing unit 107, and the subtitle generating unit 108. Furthermore, the right temple 123R includes the operation unit 110 and the sensor 111. The headset 20 includes the sound collecting unit 201 disposed near the user's mouth and the reproducing unit 203 disposed near the user's ear. Note that the constitution shown in FIG. 3 is merely an example and the exterior, the positions to which the units are attached, and the shapes are not limited thereto.

Next, an example of information displayed by the display unit 109 will be described.

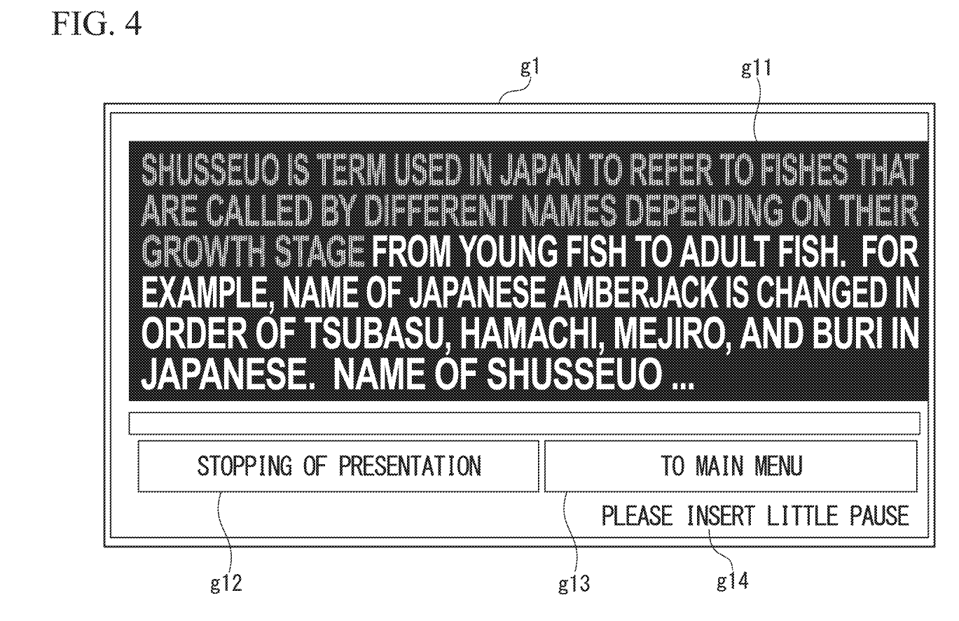

FIG. 4 is a diagram illustrating the example of the information displayed by the display unit 109 according to this embodiment. In FIG. 4, g1 is an example of an image displayed by the display unit 109. g11 is an example of subtitle data. g12 is an example of the above-described operation image and is a button image associated with stopping of a presentation. g13 is an example of an operation image and is a button image used to display a main menu. g14 is an example in which instruction information transmitted by an external apparatus is displayed as text on the display unit 109.

In the example illustrated in FIG. 4, a part of text of a manuscript file is “Shusseuo is a term used in Japan to refer to fishes that are called by different names depending on their growth stage from a young fish to an adult fish. For example, a name of the Japanese amberjack changes in the order of tsubasu, hamachi, mejiro, and buri in Japanese.” The user serving as the presenter performs a presentation while viewing subtitles displayed on the display unit 109. The user sequentially reads from the beginning of the subtitles. Note that, in the expression “Shusseuo is a term used in Japan to refer to fishes that are called by different names depending on their growth stage from a young fish to an adult fish” in the example of FIG. 4, the expression “Shusseuo is a term” is set to a first set of syllables, the expression “used in Japan” is set to a second set of syllables, the expression “to refer to fishes” is set to a third set of syllables, the expression “that are called by different names” is set to a fourth set of syllables, the expression “depending on their growth stage” is set to a fifth set of syllables, the expression “from a young fish” is set to a sixth set of syllables, and the expression “to an adult fish” is set to a seventh set of syllables.

Also, the example illustrated in FIG. 4 is an example of subtitle data displayed on the display unit 109 when the user reads the expression “Shusseuo is a term used in Japan to refer to fishes that are called by different names depending on their growth stage”. At this time, the subtitle generating unit 108 acquires a recognition result of “growth stage”. Furthermore, the subtitle generating unit 108 determines that the acquired recognition result is the fifth set of syllables of the manuscript file. Accordingly, the subtitle generating unit 108 generates subtitle data in which a display color of the expression “Shusseuo is a term used in Japan to refer to fishes that are called by different names depending on their growth stage” is changed. The example illustrated in FIG. 4 is an example in which the display color of the expression “Shusseuo is a term used in Japan to refer to fishes that are called by different names depending on their growth stage” is changed from white to black. In other words, in this embodiment, a display color of a portion prior to a portion which the user has read is changed so that the user cannot see it. Note that, although a case in which a display color of subtitles is changed has been described in the above-described example, the present invention is not limited thereto. The subtitle generating unit 108 may mask a display region of the expression “Shusseuo is a term used in Japan to refer to fishes that are called by different names depending on their growth stage”, for example, using black so that the display of the expression “Shusseuo is a term used in Japan to refer to fishes that are called by different names depending on their growth stage” is hidden.

Also, when the expression “please insert a little pause” is received from an external apparatus as instruction information, as shown in g14, the subtitle generating unit 108 displays this instruction information in a region other than a presentation unit used to present a manuscript file. For example, co-presenters may transmit instruction information to the presenter using an external apparatus. Thus, according to this embodiment, an instruction can be presented to the presenter using character information and thus the presenter can proceed with a presentation in accordance with the instruction. As a result, according to this embodiment, a presentation can be efficiently and smoothly performed. Note that, although a case in which instruction information is presented on the display unit 109 has been described in the example illustrated in FIG. 4, the present invention is not limited thereto. For example, when instruction information is sound signals, the subtitle generating unit 108 may transmit the sound signals to the headset 20 and the reproducing unit 203 may reproduce the received sound signals. Alternatively, even when instruction information is text information, the subtitle generating unit 108 may convert the text information into sound signals and transmit the converted sound signals to the headset 20. Alternatively, also when instruction information is sound signals, the subtitle generating unit 108 may convert the sound signals into text information and display the converted text information on the display unit 109.

Thus, according to this embodiment, the user can perform a presentation while reading a manuscript displayed on the display unit 109 in a state in which his or her face faces an audience. Furthermore, according to this embodiment, since a manuscript displayed on the display unit 109 is set such that the user cannot see text which has been read (has been presented), the user can recognize a portion which has been read (has been presented) and can appropriately read the next clause. Moreover, according to this embodiment, an operation such as starting, pausing, or ending of generation of subtitle data with respect to information displayed on the display unit 109 can be performed by the user's operation of the operation unit 110, the user's gesture, or the user's voice.

Next, a display example of a case in which the user skips a part of subtitle data will be described.

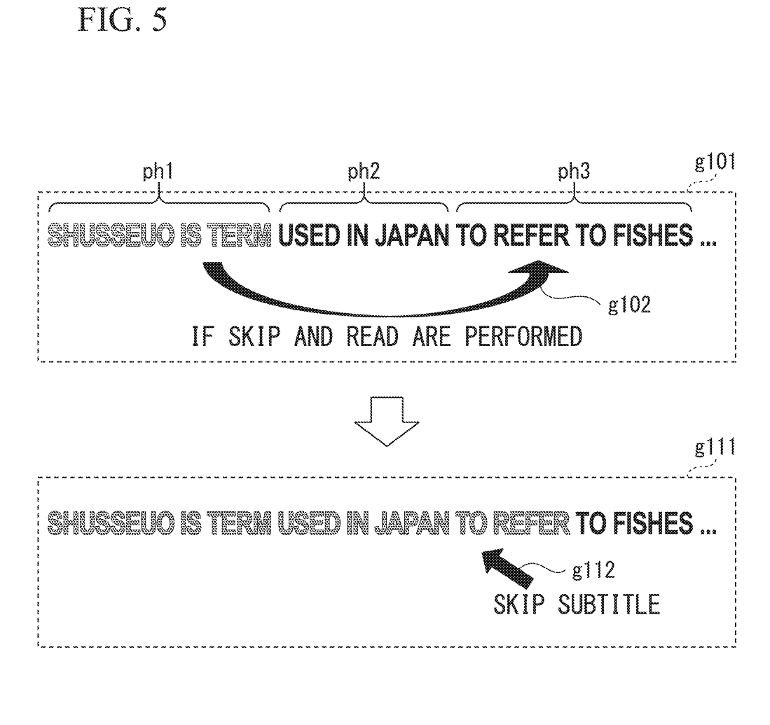

FIG. 5 is a diagram illustrating a display example when skipping has occurred according to the first embodiment. In the example illustrated in FIG. 5, text of a manuscript file includes the expression “Shusseuo is a term used in Japan to refer to fishes that are called by different names depending on their growth stage from a young fish,” and the expression “Shusseuo is a term” ph1 is the first set of syllables, the expression “used in Japan” ph2 is the second set of syllables, and the expression “to refer to fishes” ph3 is the third set of syllables.

When the user reads the expression “Shusseuo is a term” ph1 of the first set of syllables, skips the expression “used in Japan” ph2 of the second set of syllables, and reads the term “to refer” in ph3, the subtitle generating unit 108 changes a display color of the expression “used in Japan” ph2 of the second set of syllables skipped by the user to black so that it cannot be seen as shown in g101 and g111. Note that, in FIG. 5, for the purpose of explanation, a portion which has been read and a portion which has been skipped are represented in gray and a portion which is not read is represented in black.

In this embodiment, when the user skips as in an arrow g102, a portion skipped like an arrow g112 is skipped and subtitle data is displayed so that it reads from the expression “to refer to fishes” ph3 of the third set of syllables. In this case, the subtitle generating unit 108 determines that the expression “used in Japan” ph2 of the second set of syllables has been skipped, for example, when the voice recognizing unit 106 cannot recognize the term “used” after the expression “Shusseuo is a term” ph1 of the first set of syllables has been recognized. Furthermore, the subtitle generating unit 108 detects a portion which is skipped and is currently being read (hereinafter also referred to as a “skipped destination”) on the basis of an output of the voice recognizing unit 106. For example, when the term “to refer” has been recognized, the subtitle generating unit 108 detects that a skipped destination is the expression “to refer to fishes” ph3 of the third set of syllables.

The subtitle generating unit 108 detects a skipped destination in the following order. A sentence which is currently being read by the user is set to a first sentence {a first set of syllables, a second set of syllables, . . . , and an n^{th} set of syllables (n is an integer of 2 or more)}, the next sentence is set to a second sentence {a first set of syllables, a second set of syllables, . . . , and an m^{th} set of syllables (m is an integer of 2 or more)}, and the next sentence is set to a third sentence {a first set of syllables, a second set of syllables, . . . , and an o^{th} set of syllables (o is an integer of 2 or more)}. For example, the subtitle generating unit 108 recognizes a first set of syllables of the first sentence and then detects the next recognition result inside the same sentence, that is, in the order of a second set of syllables, a third set of syllables, . . . , and an n^{th} set of syllables of the first sentence. If a recognition result cannot be detected in the first sentence, then the subtitle generating unit 108 detects a first set of syllables, a second set of syllables, . . . , and an m^{th} set of syllables of the second sentence in this order. If a recognition result cannot be detected in the first sentence and the second sentence, then the subtitle generating unit 108 detects a first set of syllables, a second set of syllables, . . . , and an o^{th} set of syllables of the third sentence in this order. Note that a range of sentences detected by the subtitle generating unit 108 (a range of the number of retrieved sentences) may be within a predetermined range and may be the entire manuscript file.

Next, an example of a process procedure of an operation instruction using voice signals will be described.

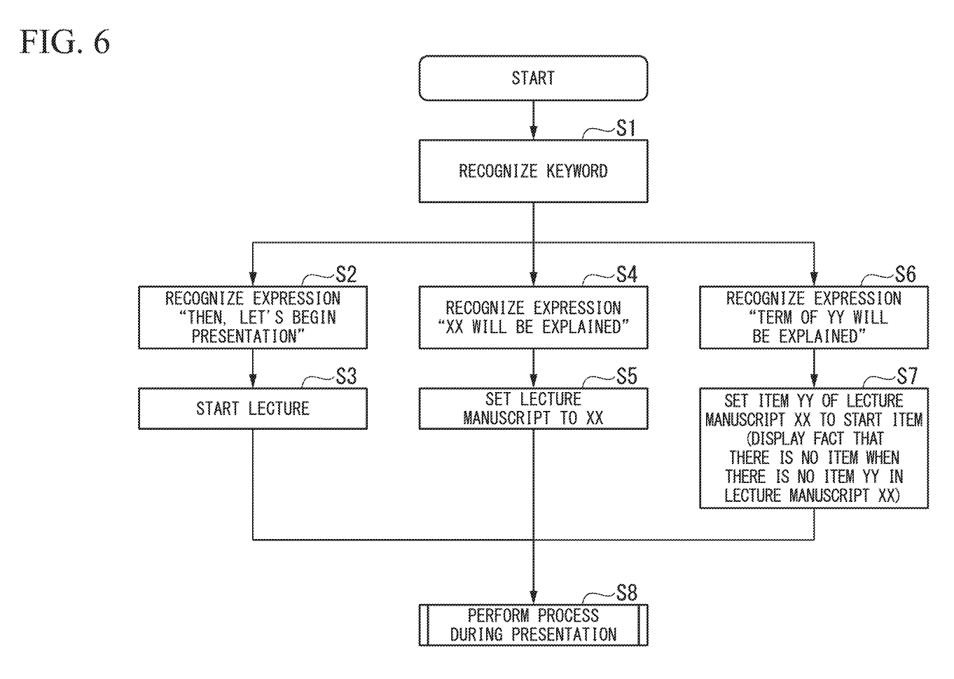

FIG. 6 is a flowchart of a process of an operation instruction using voice signals according to the first embodiment.

(Step S1) The voice recognizing unit 106 performs voice recognition on sound signals collected by the sound collecting unit 201 and recognizes a keyword of an operation instruction. When the recognized result is the expression “Then, let's begin the presentation,” the process of the voice recognizing unit 106 proceeds to a process of Step S2. When the recognized result is the expression “XX will be explained,” the process of the voice recognizing unit 106 proceeds to a process of Step S4.

When the recognized result is the expression “The terms of YY will be explained,” the process of the voice recognizing unit 106 proceeds to a process of Step S6. Note that the process of the voice recognizing unit 106 may proceed to the process of Step S2 when a keyword indicating a start, for example, the term “start,” “begin,” or the like is extracted as a result of performing voice recognition. Furthermore, the process of the voice recognizing unit 106 may proceed to the process of Step S4 when a keyword or the like indicating a title of a manuscript is extracted as a result of performing voice recognition. The process of the voice recognizing unit 106 may proceed to the process of Step S6 when a keyword or the like indicating an item is extracted as a result of voice recognition.

(Step S2) The voice recognizing unit 106 recognizes the expression “Then, let's begin the presentation” and the process thereof proceeds to a process of Step S3.

(Step S3) The subtitle generating unit 108 determines that a lecture has been started in response to an operation instruction output by the voice recognizing unit 106. For example, the subtitle generating unit 108 displays a list of titles on the display unit 109 when the scenario storing unit 107 stores a plurality of text files. The process of the subtitle generating unit 108 proceeds to a process of Step S8 after the process.

(Step S4) The voice recognizing unit 106 recognizes the expression “XX will be explained” and the process thereof proceeds to a process of Step S5.

(Step S5) The subtitle generating unit 108 sets a lecture manuscript to XX in response to an operation instruction output by the voice recognizing unit 106. The process of the subtitle generating unit 108 proceeds to the process of Step S8 after the process.

(Step S6) The voice recognizing unit 106 recognizes the expression “The term of YY will be explained” and the process thereof proceeds to a process of Step S7.

(Step S7) The subtitle generating unit 108 sets an item YY of a lecture manuscript XX to a start item in response to an operation instruction output by the voice recognizing unit 106. The subtitle generating unit 108 displays the fact that there is no item on the display unit 109 when there is no item YY in the lecture manuscript XX. The process of the subtitle generating unit 108 proceeds to the process of Step S8 after the process.

(Step S8) The voice processing apparatus 1 performs a process during the presentation and repeatedly performs the above-described process of the operation instruction using the voice signals until a keyword indicating an end of a presentation or an utterance of “Then, the presentation ends” is recognized.

As described above, in this embodiment, the voice processing apparatus 1 performs the process on the basis of the voice recognition. Note that the voice processing apparatus 1 may end the above-described process of the operation instruction using the voice signals even when the user operates the operation unit 110 and selects an operation instruction used to end a presentation.

Next, an example of a process procedure during a presentation in Step S8 of FIG. 6 will be described.

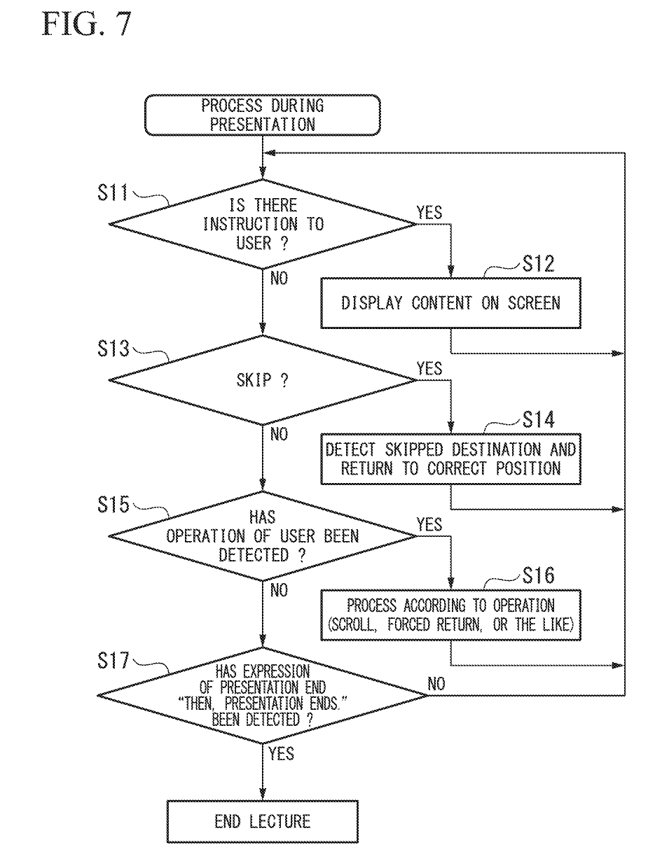

FIG. 7 is a flowchart of a process during a presentation according to the first embodiment.

(Step S11) The subtitle generating unit 108 determines whether the receiving unit 202 outputs instruction information to the user (the presenter). Here, instruction information for the user includes an instruction to pause a presentation, an instruction for a motion (a description of a motion or the like using a body gesture, a hand gesture, a pointer, or the like) for the presenter, an instruction used to inform the user of the existence of a questioner, and the like. The process of the subtitle generating unit 108 proceeds to a process of Step S12 when it is determined that instruction information has been output to the user (Step S11; YES) and the process thereof proceeds to a process of Step S13 when it is determined that instruction information has not been output to the user (Step S11; NO).

(Step S12) the subtitle generating unit 108 displays instruction information output by the receiving unit 202 in a region (for example, outside of) other than a presentation unit configured to present text of a manuscript file. The process of the subtitle generating unit 108 returns to the process of Step S11 after the process.

(Step S13) The subtitle generating unit 108 determines whether skipping has occurred on the basis of an output of the voice recognizing unit 106. The process of the subtitle generating unit 108 proceeds to a process of Step S14 when it is determined that skipping has occurred (Step S13; YES) and the process thereof proceeds to a process of Step S15 when it is determined that skipping has not occurred (Step S13; NO).

(Step S14) the subtitle generating unit 108 detects a skipped destination on the basis of the voice recognizing unit 106 and changes display of text so that the skipped destination becomes a correct reading portion as shown in FIG. 5. The process of the subtitle generating unit 108 returns to the process of Step S11 after the process.

(Step S15) The subtitle generating unit 108 detects whether the operation unit 110 has been operated or detects whether an operation instruction has been performed through a gesture, that is, determines whether an operation of the user has been detected. The process of the subtitle generating unit 108 proceeds to a process of Step S16 when it is determined that an operation of the user has been detected (Step S15; YES) and the process thereof proceeds to a process of Step S17 when it is determined that an operation of the user has not been detected (Step S15; NO).

(Step S16) the subtitle generating unit 108 detects an operation instruction on the basis of an operation result detected by the operation unit 110 or detects an operation instruction on the basis of a detection value of the sensor 111. Subsequently, the subtitle generating unit 108 performs a process according to an operation instruction. Here, operation instructions are associated with, for example, a process used to vertically scroll text displayed on the display unit 109, a process used to forcedly return to the original process when estimation of a skipped destination is incorrect, a presentation is done over again in the middle thereof, and the like. The process of the subtitle generating unit 108 returns to the process of Step S11 after the process.

(Step S17) The subtitle generating unit 108 detects a phrase or a keyword used to end a presentation on the basis of the voice recognizing unit 106. A phrase used to end a presentation is, for example, the expression “Then, the presentation ends.” The subtitle generating unit 108 determines that a lecture (a presentation) has been ended when it is determined that a phrase or a keyword used to end a presentation has been detected (Step S17; YES) and ends the process. The process of the subtitle generating unit 108 returns to the process of Step 11 when it is determined that a phrase or a keyword used to end a presentation has not been detected (Step S17; NO).

The process procedure shown in FIG. 7 is merely an example and the present invention is not limited thereto. The voice processing apparatus 1 may perform the process of Step S11, for example, after the process of Step S13 or after the process of Step S15.

As described above, in this embodiment, display of a portion which has been read (for example, a word, a phrase, a clause, and the like) is changed so that the portion cannot be seen. Thus, according to this embodiment, effects in which the user can be guided to easily talk about a predetermined scenario can be obtained. Furthermore, according to this embodiment, since the user performs a presentation while viewing text which is displayed on the display unit 109 and in which a result of voice recognition is reflected, the user can perform the presentation while his or her face faces an audience. Note that, although a case in which display of a portion which has been read is changed so that the portion cannot be seen has been described in the above-described example, the present invention is not limited thereto. A manner of displaying may change display of a portion which has been read and include changing a color, changing brightness, masking, changing transparency by masking, and the like.

Also, according to this embodiment, since voice recognition is performed on a portion (a clause or the like) read by the user, display of a portion which is skipped by the user is changed so that the portion cannot be seen when skipping has occurred. Thus, the user can read text of a skipped destination so that the presentation can be smoothly continued. As a result, according to this embodiment, efficiency or an effect of a presentation in a situation such as a conference can be improved.

According to this embodiment, the user can perform an operation instruction on the voice processing apparatus 1 using a voice. As a result, according to this embodiment, a process associated with reproducing, pausing, stopping, or the like of desired content can be performed on the basis of the user's operation instruction. In other words, according to this embodiment, selection of content (a manuscript file) and selection of an item of a chapter or the like within content can be performed through a voice instruction. According to this embodiment, display of text can be started or ended in accordance with a voice instruction.

According to this embodiment, the user can operate the operation unit 110 or operate the operation unit 110 through a gesture to perform an operation instruction on the voice processing apparatus 1.

In this embodiment, the scenario storing unit 107 stores text for each item in a manuscript file and detects using voice recognition that the user has instructed the apparatus to start an item through his or her voice. Thus, according to this embodiment, text can be reproduced from desired content (an item, a chapter, or the like) of the user.

### Second Embodiment

Although a case in which the voice processing apparatus 1 includes all constituent elements of the HMD 10 and all constituent elements of the headset 20 has been described in the first embodiment, a part of the constituent elements may be included in a server or the like over a network.

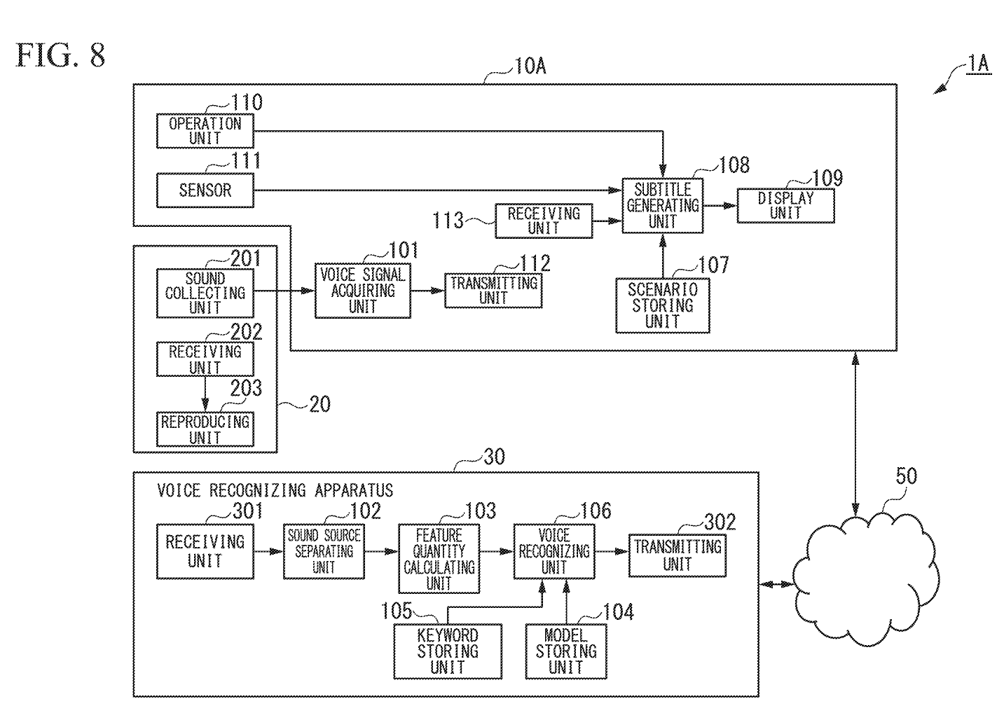

FIG. 8 is a block diagram showing a constitution of a voice processing apparatus 1A according to this embodiment. Note that constituent elements having functions which are the same as those of the voice processing apparatus 1 (FIG. 1) are denoted with the same reference numerals.

As shown in FIG. 8, the voice processing apparatus 1A includes an HMD 10A, a headset 20, and a voice recognizing apparatus 30. The HMD 10A and the voice recognizing apparatus 30 are connected over a network 50. The network 50 may be a network such as a telephone communication circuit, an internet circuit, a radio circuit, and a wired circuit.

The HMD 10A includes a voice signal acquiring unit 101, a scenario storing unit 107, a subtitle generating unit 108, a display unit 109, an operation unit 110, a sensor 111, a transmitting unit 112, and a receiving unit 113.

The voice recognizing apparatus 30 includes a sound source separating unit 102, a feature quantity calculating unit 103, a model storing unit 104, a keyword storing unit 105, a voice recognizing unit 106, a receiving unit 301, and a transmitting unit 302.

The HMD 10A acquires sound signals collected by the headset 20 and transmits the acquired sound signals to the voice recognizing apparatus 30 via the transmitting unit 112 and the network 50. The HMD 10A displays a text file of a scenario stored in its own unit on the display unit 109 to present the text file to the user. The HMD 10A receives a result recognized by the voice recognizing apparatus 30 via the network 50 and the receiving unit 113. The HMD 10A sets a portion which has been read by the user (a clause, a sentence, or the like) so that the portion cannot be seen on the basis of a result of voice recognition by the voice recognizing apparatus 30. The HMD 10A detects whether skipping of a scenario has occurred on the basis of a result of voice recognition by the voice recognizing apparatus 30, detects a previous skipped position (a clause or the like) when skipping has occurred, and performs display of text from this position. The HMD 10A detects an operation of the user and performs starting, pausing, or stopping of display of text, starting of display for each item, and the like in accordance with the detected result.

The voice signal acquiring unit 101 outputs generated frequency domain signals to the transmitting unit 112.

The transmitting unit 112 transmits sound signals of a frequency domain output by the voice signal acquiring unit 101 to the voice recognizing apparatus 30 over the network 50.

The receiving unit 113 receives text data or an operation instruction transmitted via the voice recognizing apparatus 30 over the network 50 and outputs the received text data or operation instruction to the subtitle generating unit 108.

The voice recognizing apparatus 30 may be, for example, a server. The voice recognizing apparatus 30 receives sound signals of a frequency domain transmitted by the HMD 10A over the network 50 and performs a voice recognition process on the received sound signals. The voice recognizing apparatus 30 transmits a recognized result to the HMD 10A over the network 50.

The receiving unit 301 receives sound signals of a frequency domain transmitted by the HMD 10A over the network 50 and outputs the received sound signals of the frequency domain to the sound source separating unit 102.

When it is determined that a keyword is included in a recognized result, the voice recognizing unit 106 outputs an operation instruction corresponding to the keyword to the transmitting unit 302. When it is determined that a keyword is not included in an recognized result, the voice recognizing unit 106 outputs generated text data to the transmitting unit 302, for example, for each clause.

The transmitting unit 302 transmits text data or an operation instruction output by the voice recognizing unit 106 to the HMD 10A over the network 50.

Note that, although the voice recognizing apparatus 30 includes the sound source separating unit 102, the feature quantity calculating unit 103, the model storing unit 104, the keyword storing unit 105, and the voice recognizing unit 106 in the example illustrated in FIG. 8, the present invention is not limited thereto. The voice recognizing apparatus 30 includes at least one of the sound source separating unit 102, the feature quantity calculating unit 103, the model storing unit 104, the keyword storing unit 105, and the voice recognizing unit 106 and the HMD 10A may include other constituent elements.

Also in this embodiment, effects which are the same as those of the voice processing apparatus 1 described in the first embodiment can be obtained.

Note that a mobile terminal such as a wearable terminal, and a smartphone may include all or a part of functions of the voice processing apparatus 1 (or 1A) described in the first embodiment or the second embodiment. For example, a smartphone may include a voice signal acquiring unit 101, a subtitle generating unit 108, an operation unit 110, a sensor 111, a transmitting unit 112, a receiving unit 113, a sound collecting unit 201, a receiving unit 202, and a reproducing unit 203. In this case, the reproducing unit 203 may be a headphone or an earphone connected to the smartphone in a wired or wireless manner. Furthermore, the smartphone may transmit generated subtitle data to an HMD including a display unit 109 in a wired or wireless manner. Alternatively, the smartphone may also include the display unit 109.

Note that a program for realizing functions of a voice processing apparatus 1 (or 1A) in the present invention may be recorded on a computer-readable recording medium, the program recorded on the recording medium may be read in a computer system, and a voice recognition process, a process of generating subtitle data, skipping determination, and the like may be performed by executing the program. Note that a “computer system” mentioned herein is assumed to include an operating system (OS) and hardware such as peripheral apparatuses. Moreover, a “computer system” is also assumed to include a WWW system including a home page providing environment (or a display environment). A “computer-readable recording medium” refers to a storage apparatus such as a flexible disk, a magnetic optical disk, a read only memory (ROM), and a compact disc-read only memory (CD-ROM), a hard disk built into a computer system, and the like. In addition, a “computer-readable recording medium” is assumed to include a medium configured to hold a program for a certain period of time like a volatile memory (a random access memory (RAM)) inside a computer system serving as a server or a client when a program is transmitted over a network such as the Internet or a communication circuit such a telephone circuit.

The program may be transmitted from a computer system that stores the program in a storage apparatus or the like to another computer via a transmission medium or through a transmission wave in a transmission medium. Here, the “transmission medium” for transmitting the program refers to a medium having a function of transmitting information like a network (a communication network) such as the Internet or a communication circuit (a communication line) such as a telephone line. The program may be used to realize some of the above-described functions. In addition, the above-described program may be a so-called differential file (a differential program) in which the above-described functions can be realized using a combination of the program and a program recorded in a computer system in advance.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A voice processing apparatus comprising:
a scenario storing unit configured to store a scenario as text information;
a sound collecting unit configured to collect sound uttered by an utterer;
a voice recognizing unit configured to perform voice recognition on the sound collected by the sound collecting unit; and
a subtitle generating unit configured to read the text information from the scenario storing unit, to generate subtitles, and to change a display of a portion which has been already uttered by the utterer in a character string of the subtitles on the basis of a result of voice recognition by the voice recognizing unit.

2. The voice processing apparatus according to claim 1, wherein the subtitle generating unit detects whether skipping by the utterer has occurred in the subtitles on the basis of voice recognition in the voice recognizing unit and changes display of a portion including a corresponding portion when it is detected that the skipping by the utterer has occurred in the subtitles.

3. The voice processing apparatus according to claim 1, wherein the voice recognizing unit acquires an operation instruction from voice-recognized sound, and
the subtitle generating unit performs at least one of reproducing, pausing, and ending of the subtitles on the basis of the operating instruction.

4. The voice processing apparatus according to claim 3, wherein the scenario has been composed from a plurality of items in advance, and
the subtitle generating unit reproduces subtitles of an item designated through the operation instruction.

5. The voice processing apparatus according to claim 1, further comprising a receiving unit configured to acquire instruction information from the outside,
wherein the subtitle generating unit displays the instruction information acquired by the receiving unit in a region other than a region in which the subtitles are displayed.

6. A wearable apparatus comprising:
a scenario storing unit configured to store a scenario as text information;
a sound collecting unit configured to collect sound uttered by an utterer;
a voice recognizing unit configured to perform voice recognition on the sound collected by the sound collecting unit;
a display unit configured to display the text information; and
a subtitle generating unit configured to read the text information from the scenario storing unit, to generate subtitles, to change display of a portion which has been already uttered by the utterer in a character string of the subtitles on the basis of a result of voice recognition by the voice recognizing unit, and to display the portion on the display unit.

7. A mobile terminal comprising:
a scenario storing unit configured to store a scenario as text information;
a sound collecting unit configured to collect sound uttered by an utterer;
a voice recognizing unit configured to perform voice recognition on the sound collected by the sound collecting unit;
a display unit configured to display the text information; and
a subtitle generating unit configured to read the text information from the scenario storing unit, to generate subtitles, to change display of a portion which has been already uttered by the utterer in a character string of the subtitles on the basis of a result of voice recognition by the voice recognizing unit, and to display the portion on the display unit.

8. A voice processing method in a voice processing apparatus having a scenario storing unit configured to store a scenario as text information, the voice processing method comprising:
a sound collecting step of collecting, by a sound collecting unit, sound uttered by an utterer;
a voice recognizing step of performing, by a voice recognizing unit, voice recognition on the sound collected by the sound collecting step; and
a subtitle generating step of reading, by a subtitle generating unit, the text information from the scenario storing unit, to generate subtitles, to change display of a portion which has been already uttered by the utterer in a character string of the subtitles on the basis of a result of voice recognition by the voice recognizing unit, and to display the portion on the display unit.
